(19) United States
(12) Patent Application Publication
(10) Pub. No.: US 2003/0223186 A1
(43) Pub. Date: Dec. 4, 2003

(54) Notebook computer with low-noise keyboard

(76) Inventor: Yung-Shun Chen, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/264,543

(22) Filed: Oct. 4, 2002

(30) Foreign Application Priority Data
May 30, 2002 (TW) 91207941

(51) Int. Cl. G06F 1/16; B41J 3/54

(52) U.S. Cl. 361/680; 361/683; 400/82

(57) ABSTRACT

A notebook computer with a low-noise keyboard. The notebook computer comprises a housing, a base plate and a plurality of lift assemblies. The base plate, having a first area and a second area surrounding the first area, is disposed in the housing. The lift assemblies are disposed on the base plate. The first area is located under the plurality of lift assemblies, and the base plate defines a plurality of through holes located in the second area.

### BACKGROUND OF THE INVENTION

1. Field of the Invention

The invention relates to a notebook computer; in particular, a notebook computer with a low-noise keyboard.

2. Description of the Related Art

Heat dissipation is an important factor in the performance of a notebook computer. The trend towards increased processing speeds has led to an increase in the need for efficient heat dissipation. For instance, the size of the fan can be enlarged so as to enhance the heat dissipation. However, as the size of the fan becomes larger, the noise generated by the fan also increases.

FIG. 1a shows a normal notebook computer 100. The notebook computer 100 comprises a main portion 1 and a display portion 2. A keyboard 3 is disposed on the main portion 1, and a fan 16 is disposed in the main portion 1. The keyboard 3 comprises a plurality of key caps 11.

FIG. 1b is an exploded schematic view showing the keyboard 3, and FIG. 1c is a cross section showing a key assembly of the keyboard 3. The keyboard 3 comprises a plurality of key caps 11, a plurality of lift assemblies 12, an elastic member 13, a circuit membrane 14, and a base plate 15. It is noted that only one key cap 11 and only one lift assembly 12 are shown in FIG. 1b. In addition, to clarify the structure of the key cap 11 and the lift assembly 12, their size is slightly magnified.

The base plate 15 is disposed in the main portion 1, and comprises a plurality of supports 151 and a plurality of hooks 152.

The circuit membrane 14 is disposed in the main portion 1, and comprises a plurality of through holes 141.

The elastic member 13 is disposed in the main portion 1, and is integrally formed by rubber. The elastic member 13 comprises a body 130, a plurality of dome-shaped components 131, a plurality of connecting portions 133, and a plurality of through holes 132. The connecting portions 133 connect the dome-shaped components 131.

The lift assemblies 12 are disposed on the main portion 1, and each of the lift assemblies 12 comprises a first moving member 121 and a second moving member 122 respectively. The second moving member 122 and the first moving member 121 are pivoted together. In addition, the key caps 11 are disposed on the corresponding lift assemblies 12 respectively.

Furthermore, referring to FIG. 1b, during the assembly of the keyboard 3, the elastic member 13 and the circuit membrane 14 are disposed on the base plate 15 so that the supports 151 and the hooks 152 pass through the through holes 141, 132. The lift assemblies 12 are disposed between the base plate 15 and the key caps 11 so that the key caps 11 can move upwardly and downwardly. The first moving member 121 engages with the hooks 152 at the second end 1212, and engages with the key cap 11 at the first end 1211. The second moving member 122 engages with the key cap 11 at the first end 1221, and engages with the supports 151 at the second end 1222.

When the keyboard 3 is operated, the user presses down the key cap 11 so as to depress the dome-shaped component 131. Thus, the dome-shaped component 131 is deformed so as to be in contact with the circuit membrane 14. As a result, the circuit membrane 14 sends a responding signal.

As stated above, there is no special concern about noise when the keyboard is designed. Specifically, the relationship between the fan and the keyboard is not properly studied.

The operation of the keyboard, however, may affect the volume of the noise generated by the fan. Specifically, when the base plate 15 of the keyboard 3 is manufactured, through holes 153 are formed near the supports 151 and the hooks 152 so that the air flow generated by the fan 16 located beneath the base plate 15 can flow to outside the notebook computer 1 through the base plate 15. Furthermore, as shown in FIG. 1d, an area P of the base plate 15 is located under the lift assembly 12, and the through holes 153 are partially located in the area P. It is noted that the area P in FIG. 1d simply shows a situation in which the lift assembly 12 is totally laid on the base plate, but does not show the lift assembly 12 inclined relative to the base plate 15. However, the difference between these two situations does not affect the following description.

Based on the conventional design, since the through holes 153 are located in the area P on the base plate 12, the movement of the lift assembly 12 may interfere with air flow through the through holes 153 of the base plate 15 when the key cap 11 is operated. As a result, since the key cap 11 may interfere with the air flow passed through the base plate 15, additional noise is generated when the keyboard 3 is operated.

### SUMMARY OF THE INVENTION

In order to address the disadvantages of the aforementioned notebook computer, the invention provides a notebook computer with a low-noise keyboard.

Another purpose of this invention is to provide a notebook computer with a reduced number of through holes while maintaining the air flow generated by its fan.

Still another purpose of this invention is to provide a low-noise keyboard that does not interfere with the air flow when it is operated.

Accordingly, the invention provides a notebook computer with a low-noise keyboard. The notebook computer comprises a housing, a base plate and a plurality of lift assemblies. The base plate, having a first area and a second area surrounding the first area, is disposed in the housing. The lift assemblies are disposed on the base plate. The first area is located under the plurality of lift assemblies, and the base plate defines a plurality of through holes located in the second area.

In another preferred embodiment, the invention provides another notebook computer with a low-noise keyboard. The notebook computer comprises a housing, a base plate, a plurality of lift assemblies, and a plurality of key caps. The base plate, having a first area and a second area surrounding the first area, is disposed in the housing. The plurality of lift assemblies are disposed on the base plate, with each of the key caps disposed on the lift assembly respectively. The first area is located under the plurality of key caps, and the base plate defines a plurality of through holes located in the second area.

In another preferred embodiment, the invention provides a low-noise keyboard for a notebook computer. The keyboard comprises a plurality of lift assemblies and a base plate. The base plate supports the plurality of lift assemblies, and includes a first area located under the plurality of lift assemblies and a second area surrounding the first area. The base plate defines a plurality of through holes located in the second area.

In another preferred embodiment, the invention provides another low-noise keyboard for a notebook computer. The keyboard comprises a plurality of lift assemblies, a plurality of key caps, and a base plate. Each of the key caps is disposed on the lift assembly respectively. The base plate supports the plurality of lift assemblies, and includes a first area located under the plurality of key caps and a second area surrounding the first area. The base plate defines a plurality of through holes located in the second area.

### BRIEF DESCRIPTION OF THE DRAWINGS

The invention is hereinafter described in detail with reference to the accompanying drawings in which:

FIG. 1a is a schematic view of a conventional notebook computer;

FIG. 1b is an exploded schematic view showing a keyboard in FIG. 1a;

FIG. 1c is a cross section showing a key assembly of the keyboard in FIG. 1b;

FIG. 1d is a schematic view that shows a relationship between a base plate and a lift assembly in FIG. 1b;

FIG. 2a is a schematic view of a notebook computer as disclosed in this invention;

FIG. 2b is an exploded schematic view showing a keyboard in FIG. 2a;

FIG. 2c is a schematic view that shows a relationship between a base plate and a lift assembly in FIG. 2b; and

FIG. 2d is a schematic view that shows a relationship between a base plate and a key cap in FIG. 2b.

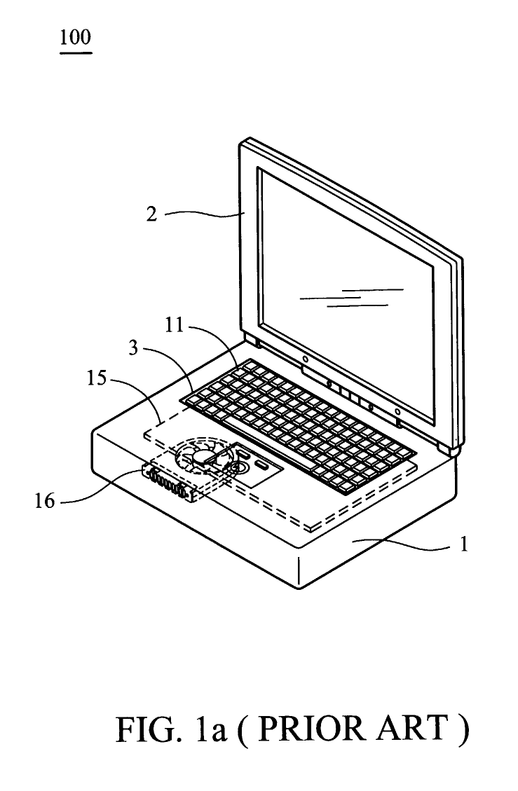

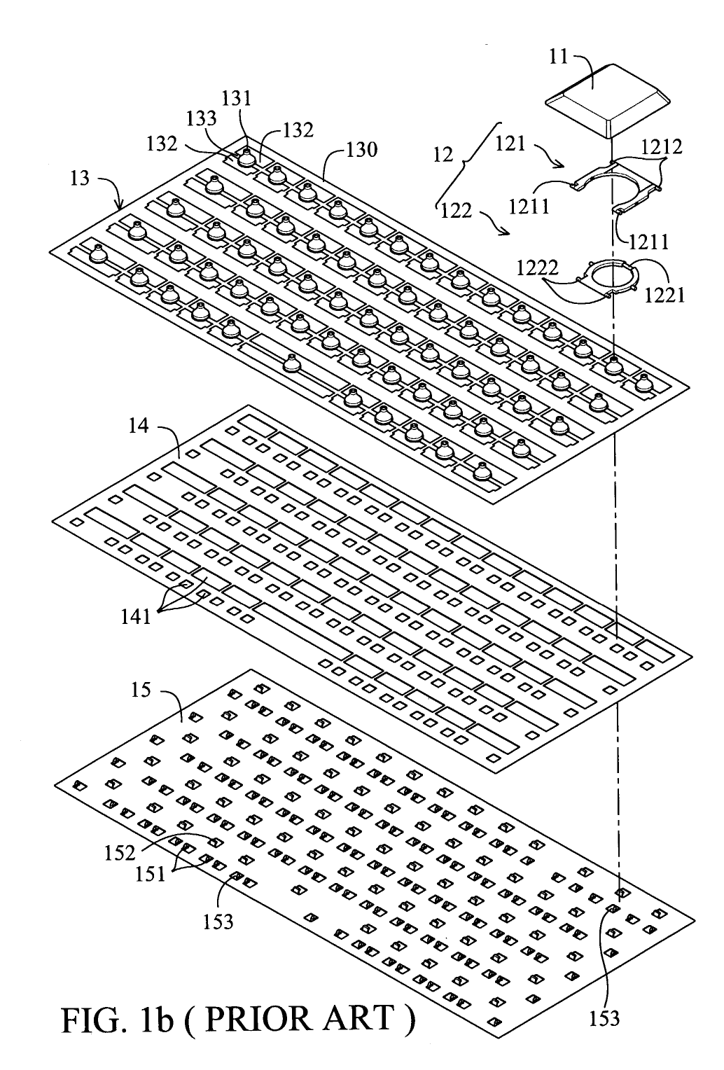

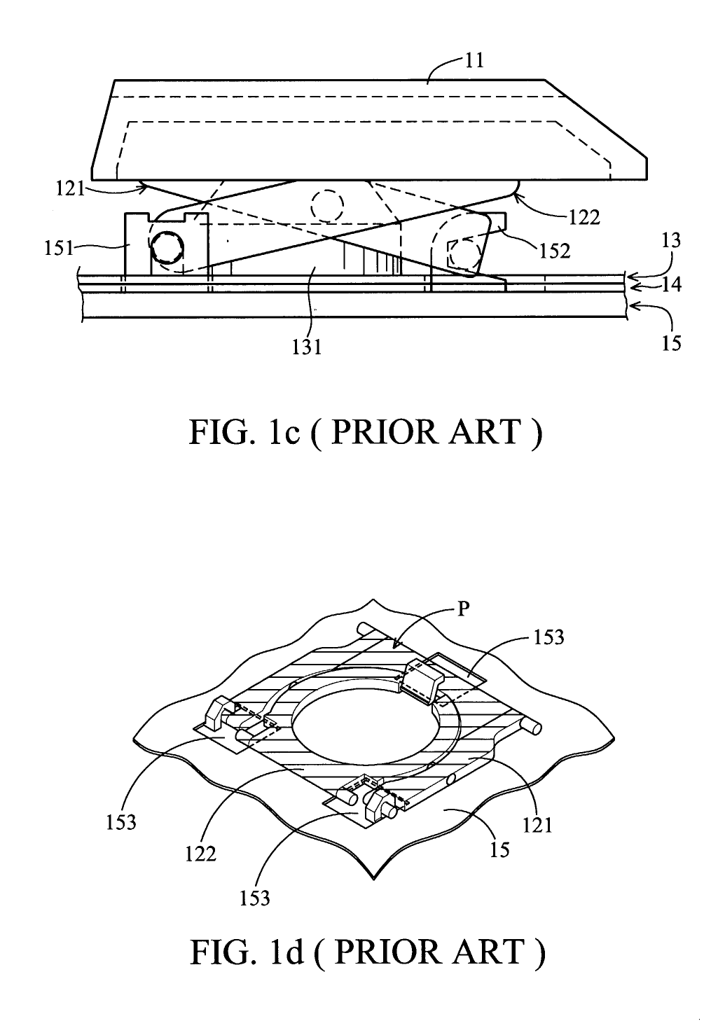

### DETAILED DESCRIPTION OF THE INVENTION

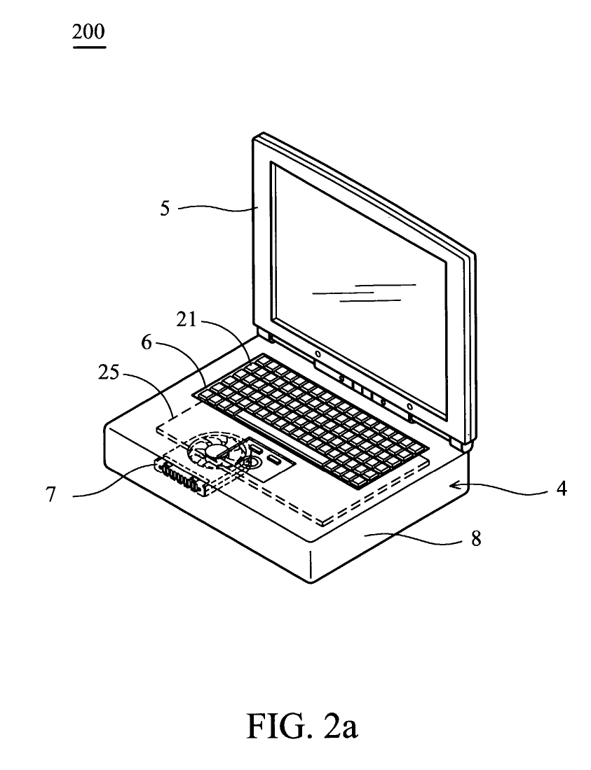

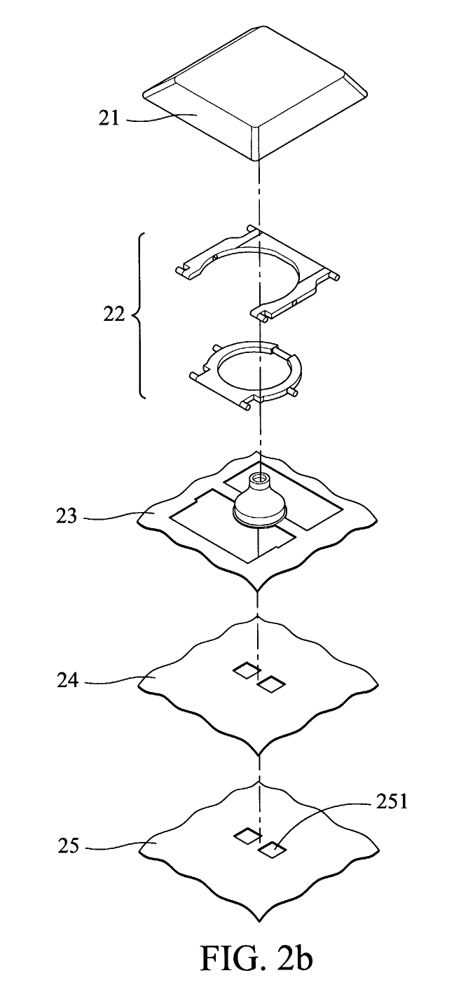

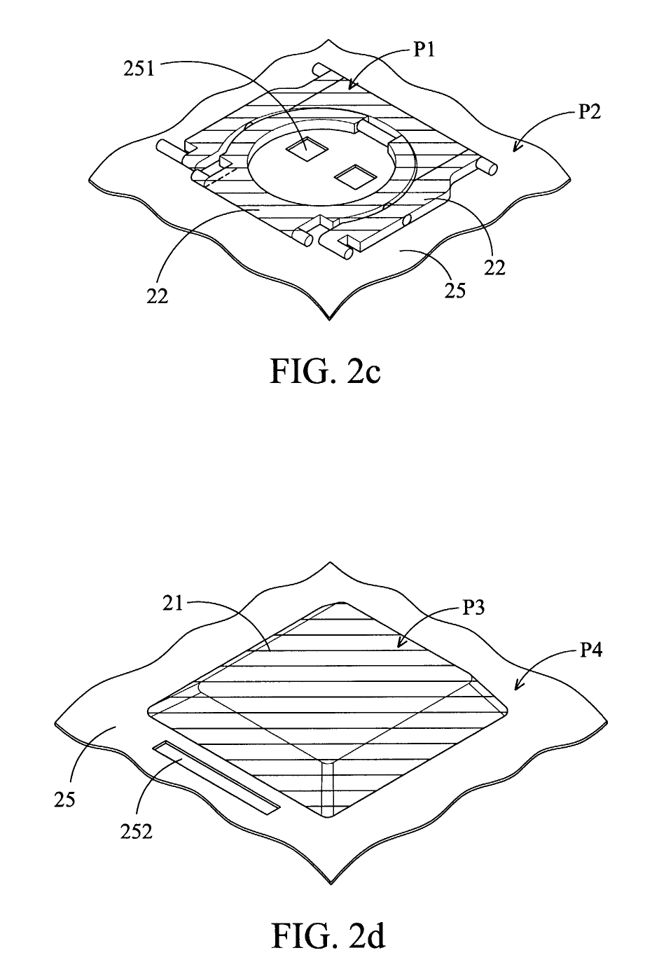

FIG. 2a shows a notebook computer 200 as disclosed in this invention. The notebook computer 200 comprises a main portion 4 and a display portion 5. The main portion 4 comprises a housing 8. A keyboard 6 is disposed on the housing 8 of the main portion 4, and a fan 7 is disposed in the housing 8 of the main portion 4. The fan 7 generates an air flow in the housing 8 of the main portion 4.

Referring to FIG. 2b, the keyboard 6 comprises a plurality of key caps 21, a plurality of lift assemblies 22, an elastic member 23, a circuit membrane 24, and a base plate 25. It is noted that only one key cap 21 and only one lift assembly 22 are shown in FIG. 2b. In addition, only part of the elastic member 23, part of the circuit membrane 24, and part of the base plate 25 are shown in FIG. 2b. Furthermore, since the key caps 21, the lift assemblies 22, the elastic member 23, and the circuit membrane 24 as disclosed in this invention are similar to those of the conventional keyboard, their detailed description is omitted. In sum, the base plate 25 is disposed in the housing 8, the lift assemblies 22 are disposed on the base plate 25, and each of the key caps 21 is disposed on the corresponding lift assembly 22 respectively.

As shown in FIG. 2c, the base plate 25 defines a plurality of through holes 251 for assisting in dissipating heat in the main portion 4. In FIG. 2c, the base plate 21 includes a first area P1 and a second area P2 surrounding the first area P1. The first area P1 is located under and corresponding to the lift assembly 22. The through hole 251 is located in the second area P2. Thus, when the lift assembly 22 moves upwardly and downwardly, it does not interfere with the air flow generated by the fan 7. As a result, the air flow easily passes through the through hole 251, and the noise due to interference by the keyboard is reduced.

It is noted that the area P1 in FIG. 2c simply shows a situation in which the lift assembly 22 is totally laid on the base plate 25, but not the lift assembly 22 inclined relative to the base plate 25. However, the difference between these two situations does not affect the description as disclosed in this invention.

Furthermore, since there is only one lift assembly 22 shown in FIG. 2c, there is only one first area P1. However, in practice, there are a plurality of first areas P1 corresponding to the number of the lift assemblies 22.

As stated above, whether the lift assembly 22 moves or not, the air flow generated by the fan 7 can smoothly pass through the through holes 251 so that the noise due to interference by the keyboard can be reduced. Thus, the number of the through holes can be reduced while maintaining the heat-dissipation efficiency. Specifically, since the through holes 251 are still formed on the base plate 25, the heat in the main portion 4 can be properly dissipated with low noise.

Furthermore, referring to FIG. 2d, the base plate 21 includes a third area P3 and a fourth area P4 surrounding the third area P3. The third area P3 is located under the key cap 21. The through hole 252 may be located in the fourth area P4 to reduce the noise as the design concept of the through hole 251.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A keyboard for a notebook computer comprising:
a plurality of lift assemblies;
a base plate supporting the plurality of lift assemblies, the base plate having a first area located under and corresponding to the plurality of lift assemblies and a second area surrounding the first area; and
at least one through part located in the second area of the base plate.

2. The keyboard of claim 1, wherein the lift assemblies include a first moving member and a second moving member, and the first moving member is pivoted with the second moving member.

3. The keyboard of claim 1, wherein the lift assemblies include a key cap, engaged with one end of the first moving member and one end of the second moving member.

4. A keyboard for a notebook computer comprising:
a plurality of lift assemblies;
a plurality of key caps disposed on the plurality of lift assemblies respectively;
a base plate supporting the plurality of lift assemblies, the base plate having a first area located under and corresponding to the plurality of key caps and a second area surrounding the first area; and
a through part located in the second area of the base plate.

5. A notebook computer comprising:
a housing; and
a keyboard located in the housing, wherein the keyboard comprises:
a base plate, having a first area and a second area surrounding the first area, disposed in the housing; and
a plurality of lift assemblies disposed on the base plate;
wherein the first area is located under and corresponding to the plurality of lift assemblies, and at least one through part is located in the second area of the base plate.
